(19) United States
(12) Patent Application Publication
(10) Pub. No.: US 2023/0258812 A1
(43) Pub. Date: Aug. 17, 2023

(54) MITIGATING CROSSTALK INTERFERENCE BETWEEN OPTICAL SENSORS

(71) Applicant: GM Cruise Holdings LLC, SAN FRANCISCO, CA (US)

(72) Inventors: Ryan Suess, Seattle, WA (US); Zhanping Xu, Sunnyvale, CA (US); Alexander Lesnick, Dublin, CA (US); Hongen Tu, San Francisco, CA (US); Min Wang, Los Altos Hills, CA (US)

(21) Appl. No.: 17/673,584

(22) Filed: Feb. 16, 2022

(51) Int. Cl. G01S 17/931; G01S 7/4911; G01S 17/08

(52) U.S. Cl. CPC G01S 17/931; G01S 7/4911; G01S 17/08; G06N 20/00

(57) ABSTRACT

Aspects of disclosed technology provide solutions for reducing interference between optical sensors and in particular, for eliminating crosstalk interference between proximally positioned Light Detection and Ranging (LiDAR) sensors (e.g., flash LiDAR sensors or full-field LiDAR sensors). A process of the disclosed technology can include steps for determining a center modulation frequency for a first Light Detection and Ranging (LiDAR) sensor, scheduling a first capture sequence for the first LiDAR sensor to occur at a first time, determining a center modulation frequency for a second LiDAR sensor, and scheduling a second capture sequence for the second LiDAR sensor to occur at a second time. Systems and machine-readable media are also provided.

### BACKGROUND

### 1. Technical Field

The disclosed technology provides solutions for reducing interference between optical sensors and in particular, for eliminating crosstalk interference between proximally positioned Light Detection and Ranging (LiDAR) sensors.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example optical sensor setup for which a crosstalk mitigation process can be implemented, according to some aspects of the disclosed technology.

FIG. 2 illustrates a block diagram of an example control system that can be configured to reduce crosstalk interference between optical sensors, according to some aspects of the disclosed technology.

FIG. 3 illustrates a flow diagram of an example process for reducing interference between optical sensors (e.g., LiDAR sensors), according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

The collection of environmental data (e.g., using various sensors) is critical to autonomous vehicle (AV) perception and planning operations. In AV deployments, vehicle-mounted sensors are commonly used to collect environmental data about an area surrounding the AV, for example, using one or more cameras, radar sensors and/or LiDAR sensors. As the number of sensors deployed in a given region (or on a given vehicle) increases, there are increasing opportunities for light transmitted by one sensor to interfere with the data capture/collection operations of other sensors. This type of crosstalk interference can be especially problematic when two or more sensors are operating in close proximity, such as when operated from/on a common vehicle, or when two vehicles employing the same type of sensor are in proximity to one another.

Aspects of the disclosed technology provide solutions for mitigating crosstalk interference between optical sensors and in particular, for eliminating interference caused by laser light transmitted by LiDAR sensors, such as full-field LiDAR sensors or flash LiDAR sensors during the course of a data capture sequence. In some aspects, crosstalk between optical sensors can be reduced or altogether eliminated by coordinating sensor operations so that the capture sequence of a given sensor (e.g., a first sensor) does not temporally overlap with that of another sensor (e.g., a second and/or a third sensor, etc.). In some approaches, time-division multiplexing of full-field LiDAR operations can be controlled by a common control system, for example, that is configured to schedule sensor operations of multiple sensors.

In some aspects, optical crosstalk can be reduced (or further reduced) through the use of frequency modulation schemes, e.g., by assigning different light modulation frequencies (center frequencies) to different sensors. In such approaches, the sensor control system can utilize modulation frequency rules to determine/assign frequency parameters to various sensors in a common environment. As discussed in further detail below, modulation frequency rules can be based on various sensor parameters or characteristics, such as the integration time of an associated image sensor.

In some aspects, LiDAR sensors may be modified such that the emitter is configured to transmit information to identify the associated sensor. For example, the emitter may be configured to transmit a sequence of bits, e.g., a preamble between transmitted waveforms. The preamble can be used to identify the corresponding flash/full-field LiDAR sensor, for example, using an index number or sensor position information. In some instances, the preamble can be used to trigger a frequency hopping command in one or more receiving devices to reshuffle the timing of capture sequences. As such, the sensor preamble can be used to configure the timing of operations of various sensors in a common vicinity. Aspects relating to the use of a sensor identification (ID) preamble are discussed in further detail below.

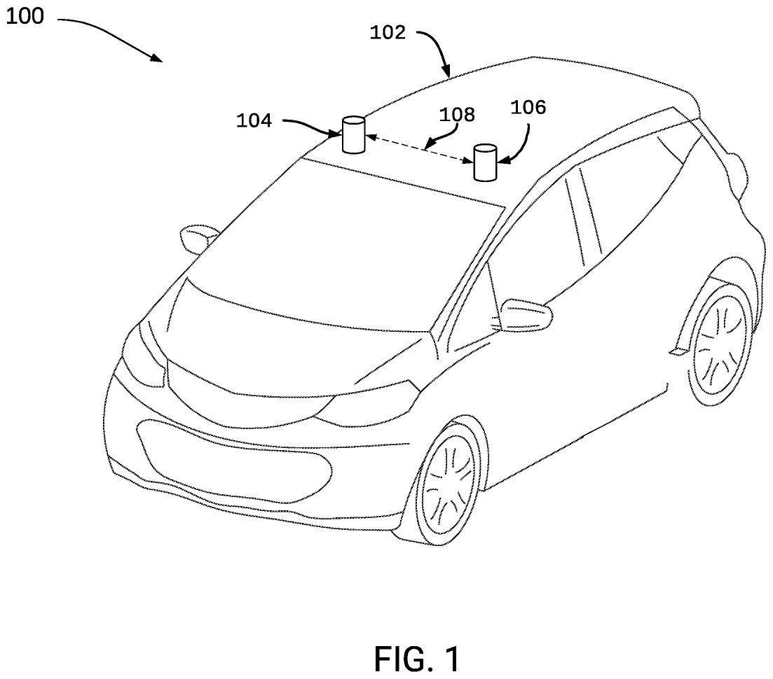

FIG. 1 illustrates an example sensor setup 100 for which a crosstalk mitigation process can be implemented. In the example setup 100 of FIG. 1, optical sensors 104, 106 are mounted to the surface of vehicle 102. In the provided example, vehicle 102 can be an autonomous vehicle (AV); however, it is understood that various other types of vehicles, or sensor implementations/configurations can be used, without departing from the scope of the disclosed technology.

In the example of FIG. 1, optical sensors 104, 106 can be optical sensors, such as full-field/flash LiDAR sensors, or other optical communication devices. In some AV implementations, LiDAR sensors (104, 106) can be used to collect environmental data for an environment around AV 102 by performing a data capture sequence in which light (e.g., laser light) is transmitted by the respective sensor, and return beams are detected using an image sensor. In other implementations, LiDAR sensors (104, 106) may be used to transmit/receive data, e.g., by transacting light signals with one or more adjacent LiDAR sensor units. Further details regarding the use of LiDAR sensors for use in optical communications is provided by U.S. application Ser. No. 17/552,930, entitled “UTILIZING LIGHT DETECTION AND RANGING SENSORS FOR VEHICLE-TO-EVERYTHING COMMUNICATIONS,” filed Dec. 16, 2021, which is entirely incorporated by reference herein.

In the example of FIG. 1, a first LiDAR sensor (e.g., LiDAR 104), and a second LiDAR sensor (e.g., LiDAR 106) can each transmit light during the course of a respective capture sequence. In instances where the capture sequences of first LiDAR sensor 104 and second LiDAR sensor 106 overlap in time (i.e., occur during concurrent time periods), interference may result from light 108 received by/at each sensor from the other. To reduce (or eliminate) the possibility of crosstalk interference between first/second LiDAR sensors (104, 106), the operational timing of each sensor may be controlled by a common sensor control system. The sensor control system (not illustrated) may be implemented locally, e.g., on the various sensors and/or on the AV. However, it is contemplated that sensor control logic may be implemented by any remote system that can be configured to communicate with the AV 102, and/or directly with sensors 104, 106. As such, sensor control logic can be used to coordinate timing between optical sensors deployed on a common vehicle, or across sensors deployed on separate vehicles, such as those associated with different vehicles in an AV fleet.

The control system (not illustrated) can be configured to schedule operations of each optical sensor (e.g., full-field/flash LiDAR sensor), so that the respective capture sequences do not overlap in time. In some implementations, the LiDAR sensors may operate at a designated frequency such as 10 Hz, such that ten capture sequences are performed per-second. The operating frequency and/or designated capture times of each sensor can be scheduled/managed by the sensor control system. For example, the operating frequency of each sensor may be adjusted based on the number of sensors deployed to a given area, or based on the operating need of the AV.

By way of example, sensor operations (e.g., transmit/capture operations) may be scheduled based on the number of sensors known to be deployed on a given vehicle, and/or based on the number of sensors known to be deployed in a common area. In such approaches, transmit operations are performed at a maximal temporal spacing between sensors implemented on a common AV, or that are known to be operated in a common vicinity. Additionally, the operating/scanning frequency may be based on the complexity of the environment/scene encountered by the AV. In such instances, the operating frequency (and operating schedules) of one or more AV sensors may be updated accordingly.

As discussed above, the capture sequence of any sensor (or all sensors in the environment) can include the transmission of data that communicates information about the transmitting sensors to other receiving sensors in the environment. For example, sensors may be modified such that the emitter is configured to transmit a series of bits (e.g., a preamble) that can be used to identify the transmitting sensor. The preamble can be transmitted between sine or square waveforms communicated by the sensor (e.g., the full-field/flash LiDAR sensor). In some instances, the preamble can be used to trigger a frequency hopping command in one or more receiving (“listening”) devices.

The preamble can also be used by a receiving/listening sensor to determine when received signals may have been contaminated by light transmissions from other sensors, e.g., in the same vicinity. By way of example, if a sensor preamble is detected prior to (or during) the initiation of a capture sequence, it may indicate that signals received by the listening sensor have been affected/contaminated by light communicated from the other sensors. Therefore, based on the detection of the preamble, the listening sensor can determine what signals should be disregarded, for example, to prevent a false perception of the surrounding environs.

In some aspects, the preamble may be used to facilitate fault or malfunction detection. For example, if the sensor operates in an optically quiet environment, e.g., without other light emitting sources, but still does not detect return signals with the expected preamble in a stable fashion, it could mean that the sensor is malfunctioning or has some internal fault. Additionally, a sensor may be identified as faulty/malfunctioning if the sensor consistently detects preambles that do not match the expectation, regardless of how the environment change (e.g., regardless in changes to aggressor sensors). As such, in some implementations, preambles may be used to perform end-of-line test, for example, of the sensor manufacturing and/or deployment process.

In another aspect, the control system can be configured to control optical modulation frequencies (e.g., center frequencies) for various transmission light sources in a manner that maximally reduces interference, e.g., for two or more sensor devices performing capture operations in an overlapping time period, or for further reducing the probability of interference for sensors operating at different time slots, as described above. In some examples, modulation frequencies for each sensor can be determined using predetermined modulation frequency assignment rules, for example, that are based on various sensor properties or characteristics.

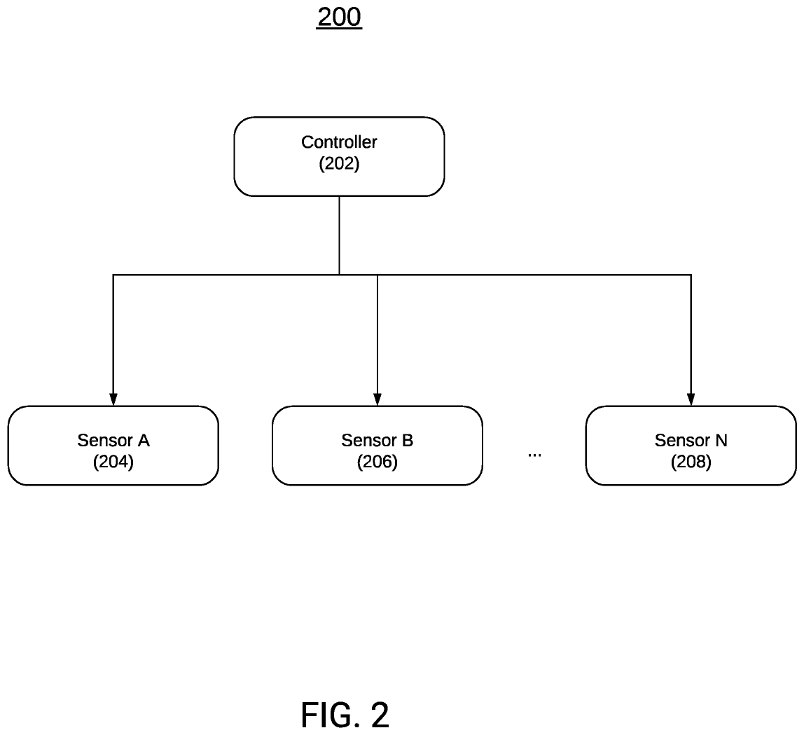

In some implementations, modulation frequency rules can depend on the integration times (or integration durations) for image capture sensors utilized by the LiDAR sensors. As discussed in further detail below, modulation frequency rules can reduce interference for any LiDAR sensors for which photon transmission is performed using a periodic function, as long as the variously transmitted waveforms do not share the same period. Therefore, the described modulation frequency assignment scheme can be broadly applied in various applications in which amplitude-modulated periodic waveforms are used to transmit data. Further details regarding the use of frequency modulation rules is discussed in further detail with respect to FIG. 2.

FIG. 2 illustrates a block diagram of an example control system 200 that can be configured to reduce crosstalk interference between optical sensors. Control system 200 includes a controller 202 that is communicatively coupled to each of sensors 204-208 (e.g., Sensor A 204, Sensor B 206, and Sensor N 208). It is understood that a greater (or fewer) number of sensors may be implemented, without departing from the scope of the disclosed technology.

In some aspects, capture sequence scheduling of sensors 204-208 can be based on the total number of sensors, the capture frequency of each sensor, as well as the capture sequence duration, and/or integration time (τ) needed by the respective sensor to complete the capture. Operation of each sensor 204-208 can be scheduled such that capture sequences performed by each sensor do not overlap in time. In some implementations, the control system 200 can be configured to separate capture operations at a maximal time spacing, for example, to reduce the likelihood of operational overlap.

In some aspects, frequency modulation parameters of various sensors can also be selected to further reduce the likelihood of sensor crosstalk. To minimize interference between LiDAR sensors, the frequency difference (or optical modulation frequency spacing) between two or more sensors can be designated using the relationship provided by equation (1):

Δfⱼₖτ=m (1)

where Δfⱼₖ is the frequency difference between two modulation frequencies f and fₖ in units of Hz as defined by equation (3) below, and τ is the integration time of the j^{th} sensor in units of seconds and m is an integer. In some aspects, a difference in modulation frequency for all sensors can be set to a frequency spacing (Δf) value provided by equation (2):

Δf=m₀/τₘᵢₙ (2)

where Δf represents the frequency spacing between sensors (e.g., for amplitude modulation frequencies of the associated transmitted optical signals), m₀ is an integer, and τₘᵢₙ represents the smallest integration time associated with any sensor for which scheduling is performed. In some implementations, using equation (2), if it is assumed that the integration time of each sensor is approximately equal, then the sensor spacing can be a multiple of Δf, e.g., to guarantee minimum interference between sensors. The frequency for a given sensor can be given by the relationship of equation (3):

f_{q}=f_{c}qΔf (2)

where f_{c} is the center modulation frequency, q is an integer, and Δf is given by equation (2). In scenarios with multiple sensors having different integration times, crosstalk can be mitigated if the integration time, τ, follows the relation provided by equation (4):

$${τ}_{P} = {τ}_{min} ( 1 + \frac{p}{m 0} ) \qquad ( 4 )$$

From equation (4) it is shown that τₚ≥τₘᵢₙ for p≥0. In such instances, a sensor with a modulation frequency fᵢ and an integration time τₚ will satisfy equation (1) in the presence of a second sensor with a modulation frequency fₖ, where fᵢ and fₖ are given by equation (3) and Δf is given by equation (2).

Using the frequency modulation rules provided by equations (1)-(4), crosstalk interference can be reduced for any two arbitrary (periodic) waveforms. That is, the modulating and demodulating waveforms can both be arbitrary and unique waveforms with different fundamental frequencies. Here we denote the modulating waveform m_{M}(t) where m_{M}(t+T)=m_{M}(t) and the demodulating waveform as m_{D}(t) with m_{D}(t+T′)=m_{D}(t) and T≠T′. By way of example, periodic modulating/demodulating waveforms can be represented using a Fourier-series amplitude-phase representation, as given by equation (5) and equation (6):

$${m}_{M} ( t ) = \frac{{A}_{0}}{2} + {Σ}_{n = 1}^{N} {A}_{n} cos ( {ω}_{n} t - {ϕ}_{n} ) \qquad ( 5 )$$

$${m}_{D} ( t ) = \frac{{A}_{0}^{′}}{2} + {Σ}_{m = 1}^{M} {A}_{m}^{′} cos ( {ω}_{m}^{′} t - {ϕ}_{m}^{′} ) \qquad ( 6 )$$

Where the prime symbol denotes the different frequency between the two signals and the coefficients Aₙ, A′ₘ and phases ϕₙ, ϕ′ₘ are real valued. The frequency is given by

$${ω}_{n} = \frac{2 π}{T} n and {ω}_{m}^{′} = \frac{2 π}{{T}^{′}} m .$$

Here m_{M}(t) represents the general modulation signals for the interfering LiDAR and m_{D}(t) represents the demodulation signals for the observing LiDAR.

In some instances, the amount of interfering light from a single unsynchronized LiDAR can be measured, for example, using two or more auxiliary measurements that can be taken to disambiguate the range to the interfering LiDAR and the frequency offset. The number of electrons generated by the interfering sensor is proportional to the inner product provided by equation (7):

N_{I}∝ [symbol] m_{M}(t−t_{d,i}),m_{D}(t−tₖ₎) [symbol] (7)

where t_{d,i} is used to denote the total time delay from the interfering LiDAR to some scene point and that scene point to the observing LiDAR and tₖ is a delay that can be set at the demodulation step. Using equations (5)-(7), and setting tₖ=0 for clarity, the number of electrons generated by the interfering signal is given by equation (8):

N_{I}∝1+2Σₙ₌₁^{N}Cₙ sinc(nΔfτ)cos(2πnΔf(t₀+τ/2)+ϕₙ−ϕ′ₙ+2ππft_{d,i}) (8)

In equation (8), t₀ is an arbitrary time offset, Cₙ is a coefficient describing the strength of the interference for a particular harmonic, and sinc is the normalized sinc function. The general interference described by equation (8) is for any two arbitrary periodic modulation and demodulation waveforms. This general interference term can be minimized by following the rules outlined in equations (1)-(4).

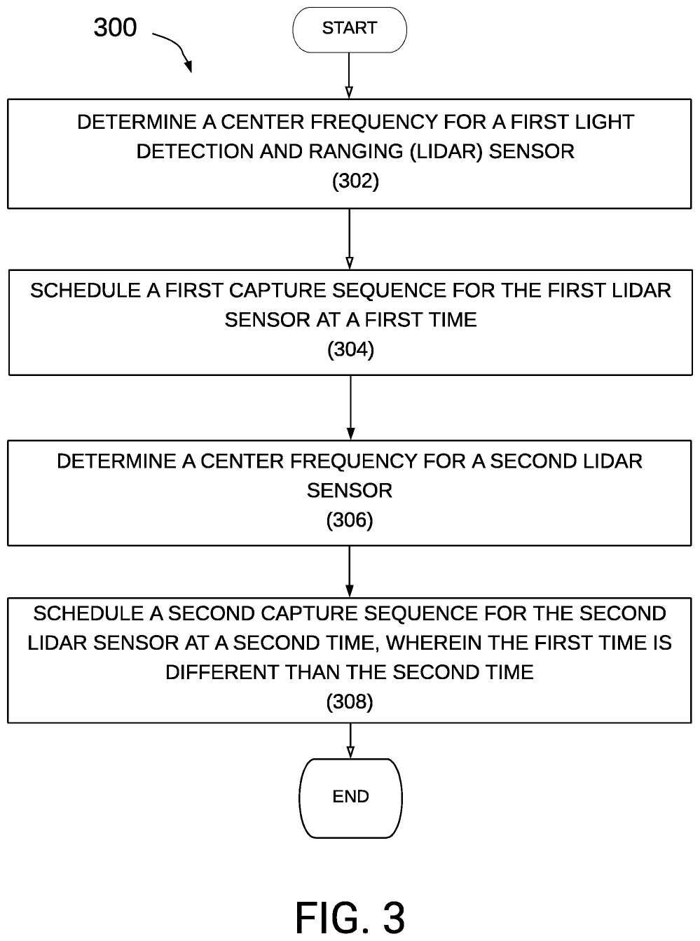

FIG. 3 illustrates a flow diagram of an example process 300 for reducing interference between optical sensors (e.g., LiDAR sensors). Process 300 begins with step 302 in which an optical modulation frequency (or center frequency) for a first LiDAR sensor is determined. As discussed above, the center frequency can be the optical modulation frequency of the associated sensor. For example, the center frequency can be based on sensor parameters of the first LiDAR and/or based on a number of other sensors and/or associated parameters. For example, the determined center frequency can be computed/determined based on an integration time (τ) required associated with the first LiDAR sensor and/or another proximally located sensor (e.g., a second LiDAR sensor). Center frequency determinations can be performed (e.g., by a sensor control system) using the relationships provided by equations (1)-(4), discussed above.

In step 304, the process 300 includes scheduling a first capture sequence for the first LiDAR sensor at a first time. As discussed above, the timing (and frequency) of capture operations can be coordinated based on a number of LiDAR sensors in the environment. In some aspects, a maximum number of LiDAR sensors, for example, on an AV may be determined based on the longest (or maximum) duty cycle of any sensor.

In step 306, the process 300 includes determining an optical modulation frequency (center frequency) for a second LiDAR sensor.

In step 308, the process 300 includes scheduling a second capture sequence for the second LiDAR sensor at a second time, wherein the time schedule for the first LiDAR sensor is different from the time scheduled for the second LiDAR sensor. In some aspects, the center frequency for the first and second LiDAR sensors, and/or for any number of additional sensors in the environment can be based on a common time element between the plurality of LiDAR sensors, and/or a minimum common time element between the plurality of LiDAR sensors.

In some approaches, the capture sequences (e.g., the first capture sequence and the second capture sequence, etc.) can each contain a series of capture frames, for example, that each have unique (different) capture time lengths or durations. In some examples, the center frequency of each of the LiDAR sensors can be based on a minimum value of a function f. By way of example, the spacing of the center frequency of each of the plurality of LiDAR sensors can be chosen from a minimum value of a function f that results in the maximum number of available LiDAR sensors to operate concurrently with the least possible interference. In some approaches, the spacing of the center frequency of each of the plurality of LiDAR sensors can be chosen from a minimum value of a function f derived from a common time element between the plurality of LiDAR sensors. Depending on the desired implementation, the function f can derive from a sinc function.

In some implementations, the function f can have minima at multiple locations being an integer multiple of a frequency bandwidth d such that the width of d minimizes a likelihood of interference and maximizes the number of LiDAR sensors available for concurrent operation. In some aspects, an integer N can be selected (e.g., as a multiple of d) as the frequency spacing between the plurality of LiDAR sensor center frequencies by considering an error term e resulting from internal oscillator clock drift among the plurality of LiDAR sensors.

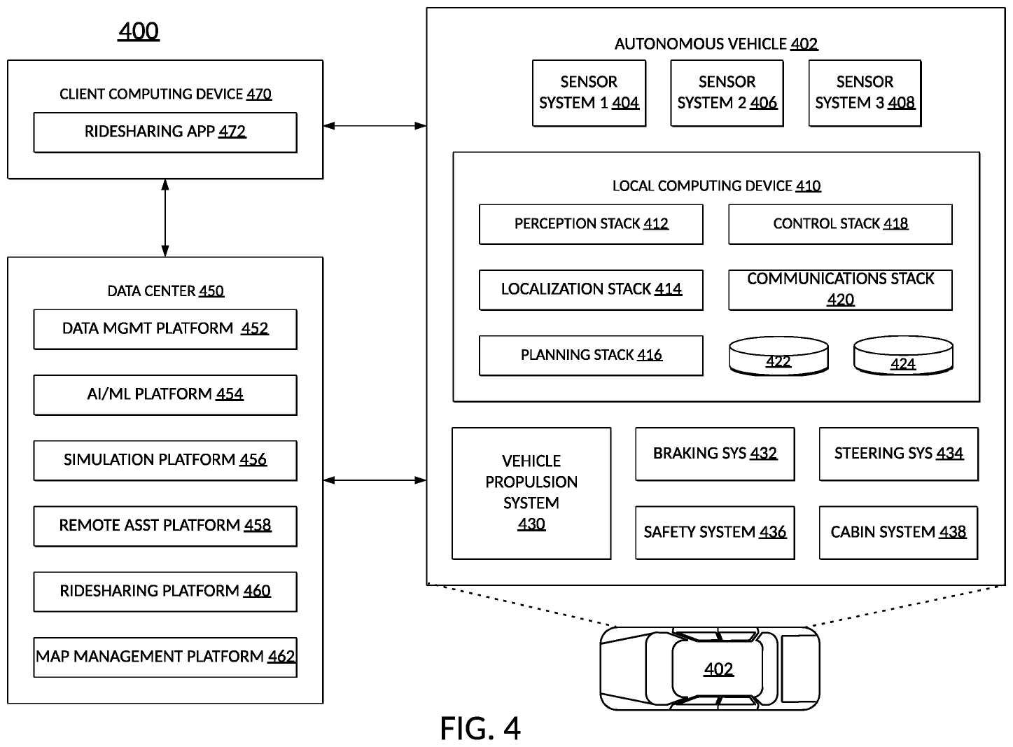

Turning now to FIG. 4 illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate about roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

AV 402 can also include several mechanical systems that can be used to maneuver or operate AV 402. For instance, the mechanical systems can include vehicle propulsion system 430, braking system 432, steering system 434, safety system 436, and cabin system 438, among other systems. Vehicle propulsion system 430 can include an electric motor, an internal combustion engine, or both. The braking system 432 can include an engine brake, brake pads, actuators, and/or any other suitable componentry configured to assist in decelerating AV 402. The steering system 434 can include suitable componentry configured to control the direction of movement of the AV 402 during navigation. Safety system 436 can include lights and signal indicators, a parking brake, airbags, and so forth. The cabin system 438 can include cabin temperature control systems, in-cabin entertainment systems, and so forth. In some embodiments, the AV 402 may not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces, e.g., Graphical User Interfaces (GUIs), Voice User Interfaces (VUIs), etc., for controlling certain aspects of the mechanical systems 430-438.

AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a planning stack 416, a control stack 418, a communications stack 420, an HD geospatial database 422, and an AV operational database 424, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 422, other components of the AV, and other data sources (e.g., the data center 450, the client computing device 470, third-party data sources, etc.). The perception stack 412 can detect and classify objects and determine their current and predicted locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth.

In some aspects, the perception stack 412 can be configured to perform operations necessary for identifying blinker state information for one or more traffic participants. As such, perception stack can be configured to perform one or more of the operations of FIG. 3, discussed above.

Mapping and localization stack 414 can determine the AV's position and orientation (pose) using different methods from multiple systems (e.g., GPS, IMUs, cameras, LIDAR, RADAR, ultrasonic sensors, the HD geospatial database 422, etc.). For example, in some embodiments, the AV 402 can compare sensor data captured in real-time by the sensor systems 404-408 to data in the HD geospatial database 422 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The planning stack 416 can determine how to maneuver or operate the AV 402 safely and efficiently in its environment. For example, the planning stack 416 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another. The planning stack 416 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 416 can select from multiple backup plans to carry out. For example, while preparing to change lanes to turn right at an intersection, another vehicle may aggressively cut into the destination lane, making the lane change unsafe. The planning stack 416 could have already determined an alternative plan for such an event, and upon its occurrence, help to direct the AV 402 to go around the block instead of blocking a current lane while waiting for an opening to change lanes.

The control stack 418 can manage the operation of the vehicle propulsion system 430, the braking system 432, the steering system 434, the safety system 436, and the cabin system 438. The control stack 418 can receive sensor signals from the sensor systems 404-408 as well as communicate with other stacks or components of the local computing device 410 or a remote system (e.g., the data center 450) to effectuate operation of the AV 402. For example, the control stack 418 can implement the final path or actions from the multiple paths or actions provided by the planning stack 416. This can involve turning the routes and decisions from the planning stack 416 into commands for the actuators that control the AV's steering, throttle, brake, and drive unit.

The communication stack 420 can transmit and receive signals between the various stacks and other components of the AV 402 and between the AV 402, the data center 450, the client computing device 470, and other remote systems. The communication stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 420 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 422 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic control layer can include geospatial information of traffic signal lights, traffic signs, and other road objects and related attributes.

The AV operational database 424 can store raw AV data generated by the sensor systems 404-408 and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data as discussed further below with respect to FIG. 2 and elsewhere in the present disclosure.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and client computing device 470. These signals can include sensor data captured by the sensor systems 404-408, roadside assistance requests, software updates, ridesharing pick-up and drop-off instructions, and so forth. In this example, the data center 450 includes a data management platform 452, an artificial intelligence/machine learning (AI/ML) platform 454, a simulation platform 456, a remote assistance platform 458, a ridesharing platform 460, and map management system platform 462, among other systems.

Data management platform 452 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management system platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management system platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the map management system platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to be picked up or dropped off from the ridesharing application 472 and dispatch the AV 402 for the trip.

Map management system platform 462 can provide a set of tools for the manipulation and management of geographic and spatial (geospatial) and related attribute data. The data management platform 452 can receive LiDAR point cloud data, image data (e.g., still image, video, etc.), RADAR data, GPS data, and other sensor data (e.g., raw data) from one or more AVs 402, UAVs, satellites, third-party mapping services, and other sources of geospatially referenced data. The raw data can be processed, and map management system platform 462 can render base representations (e.g., tiles (2D), bounding volumes (3D), etc.) of the AV geospatial data to enable users to view, query, label, edit, and otherwise interact with the data. Map management system platform 462 can manage workflows and tasks for operating on the AV geospatial data. Map management system platform 462 can control access to the AV geospatial data, including granting or limiting access to the AV geospatial data based on user-based, role-based, group-based, task-based, and other attribute-based access control mechanisms. Map management system platform 462 can provide version control for the AV geospatial data, such as to track specific changes that (human or machine) map editors have made to the data and to revert changes when necessary. Map management system platform 462 can administer release management of the AV geospatial data, including distributing suitable iterations of the data to different users, computing devices, AVs, and other consumers of HD maps. Map management system platform 462 can provide analytics regarding the AV geospatial data and related data, such as to generate insights relating to the throughput and quality of mapping tasks.

In some embodiments, the map viewing services of map management system platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

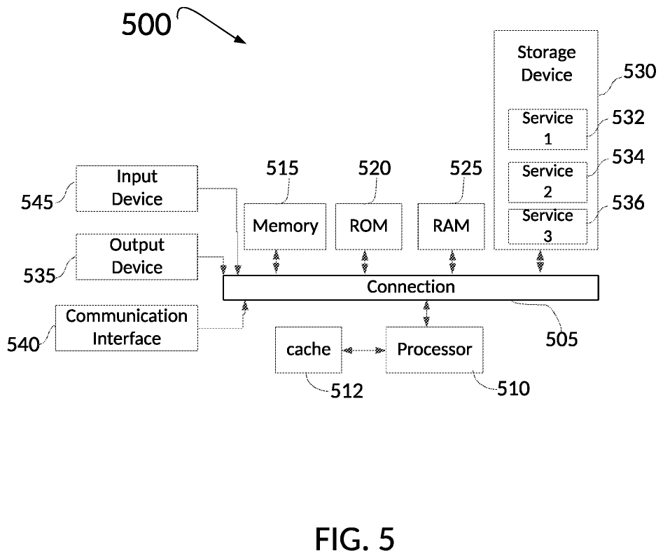

FIG. 5 illustrates an example processor-based system with which some aspects of the subject technology can be implemented. For example, processor-based system 500 can be any computing device making up internal computing system 510, remote computing system 550, a passenger device executing the rideshare app 570, internal computing device 530, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A sensor control system, comprising:
at least one memory; and
at least one processor coupled to the at least one memory, the at least one processor configured to:
determine a center frequency for a first Light Detection and Ranging (LiDAR) sensor;
schedule a first capture sequence for the first LiDAR sensor to occur at a first time;
determine a center frequency for a second LiDAR sensor; and
schedule a second capture sequence for the second LiDAR sensor to occur at a second time, wherein the first time is different than the second time.

2. The sensor control system of claim 1, wherein the center frequency for the first LiDAR sensor is based on a number of LiDAR sensors managed by the sensor control system, and wherein the center frequency for the first LiDAR sensor corresponds with a modulation frequency for a transmitter of the first LiDAR sensor.

3. The sensor control system of claim 1, wherein the center frequency for the first LiDAR sensor is based on a time duration of the first capture sequence.

4. The sensor control system of claim 1, wherein the at least one processor is further configured to:
schedule a third capture sequence for a third LiDAR sensor at a third time, wherein the third time is different than the first time and the second time.

5. The sensor control system of claim 1, wherein the first LiDAR sensor and the second LiDAR sensor are full-field LiDAR sensors.

6. The sensor control system of claim 1, wherein the first LiDAR sensor and the second LiDAR sensor are mounted on a common vehicle.

7. The sensor control system of claim 1, wherein the first LiDAR sensor and the second LiDAR sensor are mounted on different vehicles.

8. A computer-implemented method, comprising:
determining, using a sensor control system, a center frequency for a first Light Detection and Ranging (LiDAR) sensor;
scheduling, using the sensor control system, a first capture sequence for the first LiDAR sensor to occur at a first time;
determining, by the sensor control system, a center frequency for a second LiDAR sensor; and
scheduling, by the sensor control system, a second capture sequence for the second LiDAR sensor to occur at a second time, wherein the first time is different than the second time.

9. The computer-implemented method of claim 8, wherein the center frequency for the first LiDAR sensor is based on a number of LiDAR sensors managed by the sensor control system.

10. The computer-implemented method of claim 8, wherein the center frequency for the first LiDAR sensor is based on a time duration of the first capture sequence.

11. The computer-implemented method of claim 8, further comprising:
scheduling a third capture sequence for a third LiDAR sensor to occur at a third time, wherein the third time is different than the first time and the second time.

12. The computer-implemented method of claim 8, wherein the first LiDAR sensor and the second LiDAR sensor are full-field LiDAR sensors.

13. The computer-implemented method of claim 8, wherein the first LiDAR sensor and the second LiDAR sensor are mounted on a common vehicle.

14. The computer-implemented method of claim 8, wherein the first LiDAR sensor and the second LiDAR sensor are mounted on different vehicles.

15. A non-transitory computer-readable storage medium comprising at least one instruction for causing a computer or processor to:
determine a center frequency for a first Light Detection and Ranging (LiDAR) sensor;
schedule a first capture sequence for the first LiDAR sensor to occur at a first time;
determine a center frequency for a second LiDAR sensor; and
schedule a second capture sequence for the second LiDAR sensor to occur at a second time, wherein the first time is different than the second time.

16. The non-transitory computer-readable storage medium of claim 15, wherein the center frequency for the first LiDAR sensor is based on a number of LiDAR sensors managed by a sensor control system.

17. The non-transitory computer-readable storage medium of claim 16, wherein the center frequency for the first LiDAR sensor is based on a time duration of the first capture sequence.

18. The non-transitory computer-readable storage medium of claim 16, wherein the at least one instruction is further configured to cause the computer or processor to:
schedule a third capture sequence for a third LiDAR sensor to occur at a third time, wherein the third time is different than the first time and the second time.

19. The non-transitory computer-readable storage medium of claim 15, wherein the first LiDAR sensor and the second LiDAR sensor are full-field LiDAR sensors.

20. The non-transitory computer-readable storage medium of claim 15, wherein the first LiDAR sensor and the second LiDAR sensor are mounted on a common vehicle.
